(19) United States
(12) Patent Application Publication
(10) Pub. No.: US 2025/0054304 A1
(43) Pub. Date: Feb. 13, 2025

(54) IMAGE PROCESSING DEVICE, IMAGE PROCESSING METHOD, AND NON-TRANSITORY COMPUTER-READABLE MEDIUM

(71) Applicant: NEC Corporation, Minato-ku, Tokyo (JP)

(72) Inventors: Ryo KAWAI, Tokyo (JP); Noboru YOSHIDA, Tokyo (JP); Jianquan LIU, Tokyo (JP)

(73) Assignee: NEC Corporation, Minato-ku, Tokyo (JP)

(21) Appl. No.: 18/719,987

(22) PCT Filed: Dec. 27, 2021
(86) PCT No.: PCT/JP2021/048642

§ 371 Date: Jun. 14, 2024

(51) Int. Cl. G06V 20/40; G06T 7/246; G06V 10/44

(52) U.S. Cl. CPC G06V 20/42; G06T 7/246; G06V 10/44; G06T 2207/20044

(57) ABSTRACT

An image processing apparatus and the like that are able to generate or provide a more attractive video content are provided. An image processing apparatus includes: a feature motion determination unit that analyzes a motion of a target, based on capturing data, and determines a feature motion; a trigger detection unit that detects a trigger from the capturing data or distribution data for distribution to a viewer being generated from the capturing data; and a generation unit that extracts the determined feature motion of the target from the capturing data in response to detection of the trigger, and generates different distribution data for distribution to a viewer, based on the feature motion.

### TECHNICAL FIELD

The present disclosure relates to an image processing apparatus, an image processing method, and a non-transitory computer-readable medium.

### BACKGROUND ART

A service for distributing a video content to an audience, a viewer, or the like is performed mainly in an entertainment field such as sports and plays. Providing a more attractive video content is required in such a way that an audience, a viewer, or the like can further enjoy sports, plays, and the like.

For example, Patent Literature 1 discloses a ball game video analysis apparatus. The ball game video analysis apparatus receives a movie frame captured by each camera, calculates a track of a three-dimensional position of a ball by using a plurality of the received movie frames, determines whether action has been made by a player on the ball, based on a change in the track of the ball, selects, as an action frame, a movie frame at a timing at which the action has been made when the action has been made, and recognizes the player who has made the action from the action frame.

Further, Patent Literature 2 discloses a method for tracking a movement of an object, as an object to be tracked, having a predetermined feature in an image, based on moving image data. The moving object tracking method includes: a first step of storing, in advance, positional information about the object to be tracked in a plurality of past frames, and obtaining a predicted position of the object to be tracked in a current frame, based on the positional information about the object to be tracked in the plurality of stored past frames: a second step of extracting a candidate object having the predetermined feature unique to the object to be tracked from image data in the current frame; and a third step of assigning, as the object to be tracked, the extracted candidate object closer to the predicted position.

### CITATION LIST

### Patent Literature

[Patent Literature 1] International Patent Publication No. WO2019/225415
[Patent Literature 2] Japanese Unexamined Patent Application Publication No. 2004-046647

### SUMMARY OF INVENTION

### Technical Problem

However, a video content more attractive to a viewer, an audience, or the like cannot be still generated or provided.

An example object of the present disclosure is, in view of the problem described above, to provide an image processing apparatus, an image processing method, and a non-transitory computer-readable medium that are able to generate or provide a more attractive video content.

### Solution to Problem

An image processing apparatus according to one aspect of the present disclosure includes:
a feature motion determination unit that analyzes a motion of a target, based on capturing data, and determines one or more feature motions;
a trigger detection unit that detects a trigger from the capturing data or distribution data for distribution to one or more viewers being generated from the capturing data; and
a generation unit that extracts the determined feature motion of the target from the capturing data in response to detection of the trigger, and generates different distribution data for distribution to one or more viewers, based on the feature motion.

An image processing method according to one aspect of the present disclosure includes:
analyzing a motion of a target, based on capturing data, and determining one or more feature motions;
detecting a trigger from the capturing data or distribution data for distribution to a viewer being generated from the capturing data; and
extracting one or more of the determined feature motions of the target from the capturing data in response to detection of the trigger, and generating different distribution data for distribution to a viewer, based on the feature motion.

A non-transitory computer-readable medium according to one aspect of the present disclosure stores a program for causing a computer to execute a command including:
analyzing a motion of a target, based on capturing data, and determining one or more feature motions;
detecting a trigger from the capturing data or distribution data for distribution to one or more viewers being generated from the capturing data; and
extracting the determined feature motion of the target from the capturing data in response to detection of the trigger, and generating different distribution data for distribution to one or more viewers, based on the feature motion.

### Advantageous Effects of Invention

The present disclosure is able to provide an image processing apparatus, an image processing method, and a non-transitory computer-readable medium that are able to generate or provide a more attractive video content.

### BRIEF DESCRIPTION OF DRAWINGS

FIG. 1 is a block diagram illustrating a configuration of an image processing apparatus according to a first example embodiment:

FIG. 2 is a flowchart illustrating a flow of an image processing method according to the first example embodiment:

FIG. 3 is a diagram illustrating an overall configuration of a video distribution system according to a second example embodiment:

FIG. 4 is a block diagram illustrating a configuration of a video distribution apparatus and a user terminal according to the second example embodiment:

FIG. 5 is a diagram illustrating skeleton information about a player who takes a shot being extracted from a frame image included in video data according to the second example embodiment:

FIG. 6 is a flowchart illustrating a flow of a registration method of a registration motion ID and a registration motion sequence by a server according to the second example embodiment:

FIG. 7 is a table illustrating a representative motion according to the second example embodiment:

FIG. 8 is a table illustrating a representative trigger according to the second example embodiment:

FIG. 9 is a flowchart illustrating a flow of a video distribution method by the video distribution apparatus according to the second example embodiment:

FIG. 10 is a flowchart illustrating a flow of a video distribution method by a video distribution apparatus according to another example embodiment; and

FIG. 11 is a block diagram illustrating a configuration of an image-capturing apparatus according to a third example embodiment.

### EXAMPLE EMBODIMENT

The present disclosure will be described below with reference to example embodiments, but the disclosure in the claims is not limited to the example embodiments below. Further, all configurations described in the example embodiments are not necessarily essential as a means for solving the problem. In each of the drawings, the same elements will be denoted by the same reference signs, and duplicate description will be omitted as necessary.

### First Example Embodiment

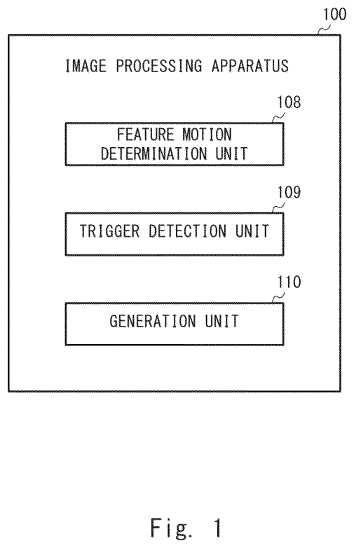

First, a first example embodiment according to the present disclosure will be described. FIG. 1 is a block diagram illustrating a configuration of an image processing apparatus 10 according to the first example embodiment. The image processing apparatus 100 may be a computer for determining one or more feature motions performed by a target from video data acquired from a camera, detecting a trigger of the video data, and generating a video in response to the detection. The image processing apparatus 100 may be, for example, a computer including a graphics processing unit (GPU), a memory, and the like. Each component in the image processing apparatus 100 can be achieved by executing a program, for example. Note that the image processing apparatus 100 may be a computer including a central processing unit (CPU), a field-programmable gate array (FPGA), a microcomputer, or the like instead of the GPU. As illustrated in FIG. 1, the image processing apparatus 100 includes a feature motion detection unit 108, a trigger detection unit 109, and a generation unit 110.

The feature motion determination unit 108 analyzes a motion of a target, based on capturing data, and determines one or more feature motions. The capturing data may be acquired from an external camera. The camera includes an image sensor such as, for example, a complementary metal oxide semiconductor (CMOS) sensor and a charge coupled device (CCD) sensor. A target may be, for example, a player in a sport, a performer in a play, a singer in a music concert, or the like. A predetermined feature motion is a characteristic motion in which the target described above attracts an audience or a viewer.

The trigger detection unit 109 detects a trigger from the capturing data or distribution data for distribution to one or more viewers being generated from the capturing data. Examples of the trigger include a change in score data, a change in volume of sound emitted from an audience, a predetermined trigger motion of a referee (or an umpire) of a game, a predetermined trigger motion of a target, and a comment of a viewer or the number of favorites in distribution data, which are not limited thereto.

The generation unit 110 extracts one or more of the determined feature motions of the target from the capturing data in response to detection of the trigger, and generates different distribution data for distribution to one or more viewers, based on the feature motion. The different distribution data may be video data about past highlights or live distribution video data that should not be missed by a viewer. In some of the example embodiments, the generation unit 110 can generate a different distribution video for a different predetermined period of time according to a kind of a trigger.

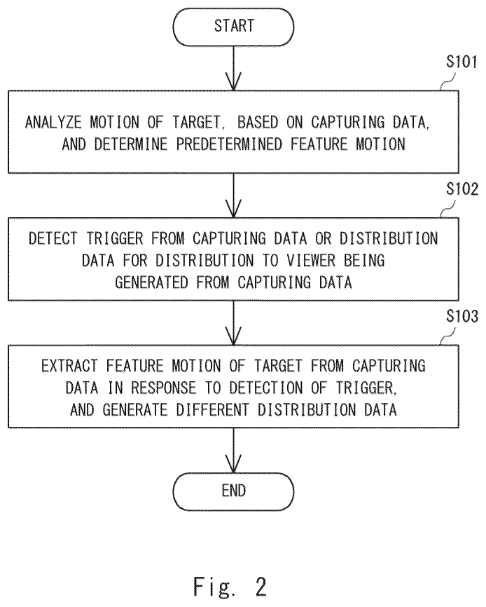

FIG. 2 is a flowchart illustrating a flow of an image processing method according to the first example embodiment.

The feature motion determination unit 108 analyzes a motion of a target, based on capturing data, and determines one or more feature motions (step S101). The trigger detection unit 109 detects a trigger from the capturing data or distribution data for distribution to one or more viewers being generated from the capturing data (step S102). The generation unit 110 extracts one or more of the determined feature motions of the target from the capturing data in response to detection of the trigger, and generates different distribution data for distribution to a viewer, based on the feature motion (for example, in such a way as to include one or more of the feature motions) (step S103).

Note that the flowchart in FIG. 2 illustrates a specific order of execution, but an order of execution may be different from the illustrated manner. For example, an order of execution of two or more steps may be switched from the illustrated order. Further, two or more steps continuously illustrated in FIG. 2 may be simultaneously or partially simultaneously executed. Furthermore, in some of the example embodiments, one or the plurality of steps illustrated in FIG. 2 may be skipped or omitted. In some of the example embodiments, an order of step S101 and step S102 in FIG. 2 may be reversed.

According to such first example embodiment, the image processing apparatus 100 can generate a video content including a feature motion of a target in response to detection of a trigger. In this way, a video content more attractive to a viewer can be provided.

### Second Example Embodiment

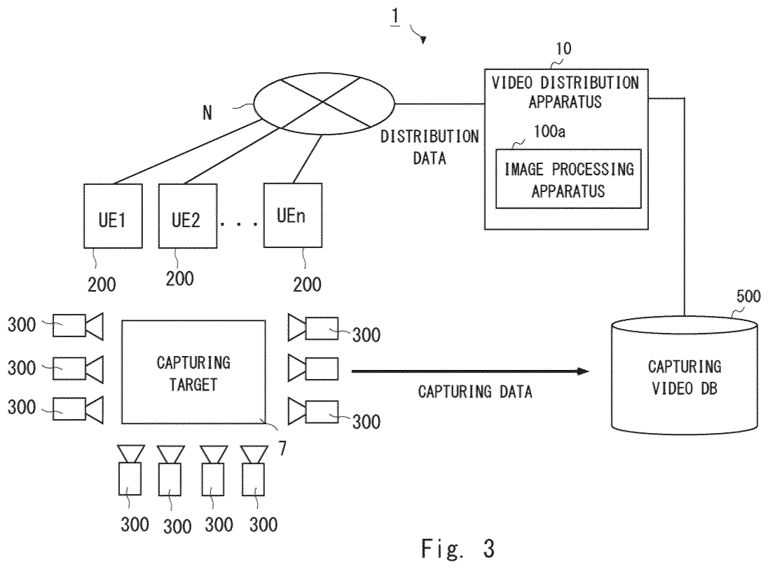

Next, a second example embodiment according to the present disclosure will be described. FIG. 3 is a diagram illustrating an overall configuration of a video distribution system 1 according to the second example embodiment. The video distribution system 1 is a computer system that can be used for creating distribution data, based on data in which a capturing target is captured by a camera, and distributing the distribution data to a terminal of a viewer. Hereinafter, a soccer game will be described as an example, but the present disclosure can also be applied to various sports such as volleyball, baseball, and basketball. Further, in addition to sports, the present disclosure can also be applied to various entertainment fields such as a play and a music concert for a purpose of being viewed by an audience and a viewer. In this case, for example, a performer or a singer may be a capturing target.

In a case of a soccer game as an example, a capturing target may be a soccer player. In a soccer field 7, 11 players on A team and 11 players on B team may be present. A plurality of cameras 300 that can capture the capturing target are disposed around the field 7. In some of the example embodiments, the camera 300 may be a skeleton camera. Many audiences may be present in audience seats of a stadium, and may each possess a user terminal 200. Further, in some of the example embodiments, the user terminal 200 may be a computer used by a viewer who views a video of a soccer game at home or the like. The user terminal 200 may be a smartphone, a tablet computer, a laptop computer, a wearable device, a desktop computer, or any suitable computer.

A capturing video database 500 can store capturing data captured by the plurality of cameras 300. The capturing video database 500 is connected to the camera 300 and a video distribution apparatus 10 described below via a wired or wireless network. In some of the example embodiments, the camera 300 may be a drone-mounted camera or a vehicle-mounted camera.

The video distribution apparatus 10 can combine desired video data from the capturing video database 500, and generate distribution data for an audience of a stadium and a viewer of a TV, Internet distribution, and the like. Further, the video distribution apparatus 10 may include an image processing apparatus 100a as one example of the image processing apparatus 100 described in the first example embodiment. The video distribution apparatus 10 can distribute generated distribution data to each user terminal via a network N. The network N may be wired or may be wireless.

The image processing apparatus 100a can acquire video data from the camera 300 or the capturing video database 500, detect one or more feature motions of a player being a capturing target, and create a video in which the feature motion is extracted. Note that, as illustrated in FIG. 3, the image processing apparatus 100a may be a function of a part of the video distribution apparatus 10, but may be achieved by a single apparatus different from the video distribution apparatus 10.

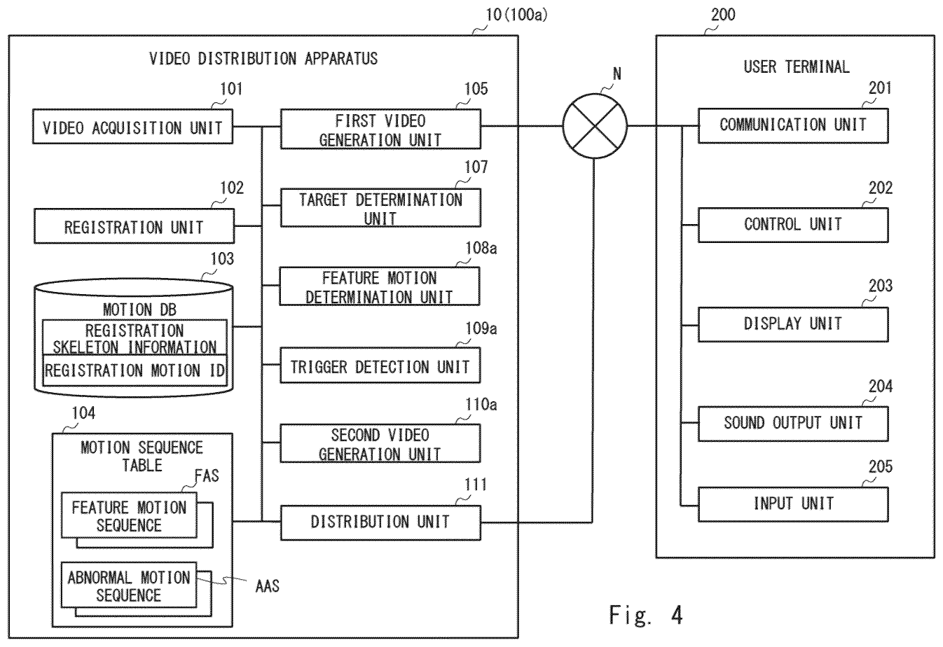

FIG. 4 is a block diagram of an exemplification illustrating a configuration of the video distribution apparatus and the user terminal. The video distribution apparatus 10 may include a video acquisition unit 101, a registration unit 102, a motion database 103, a motion sequence table 104, a first video generation unit 105, a target determination unit 107, a feature motion determination unit 108a, a trigger detection unit 109a, a second video generation unit 110a, and a distribution unit 111. Note that the configuration of the video distribution apparatus 10 is not limited to this, and various modifications may be performed. For example, the video distribution apparatus 10 may include the capturing video database 500 in FIG. 3.

The video acquisition unit 101 is also referred to as a video acquisition means. The video acquisition unit 101 can acquire desired video data from the capturing video database 500, or directly from the camera 300. As described above, there are the plurality of cameras 300 around the field, and a video of the specific camera 300 that captures, for example, a desired target or a desired scene (for example, a scene where a soccer ball is present) among the cameras 300 may be acquired.

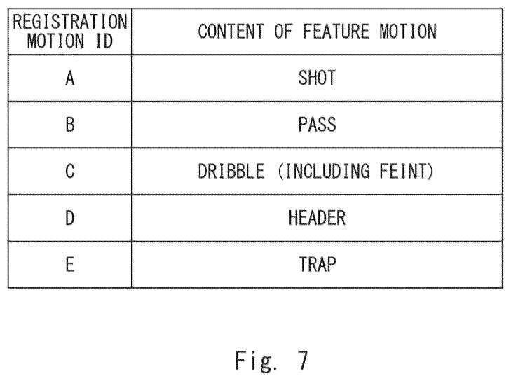

The registration unit 102 is also referred to as a registration means. First, the registration unit 102 performs feature motion registration processing in response to a registration request from an operator. Specifically, the registration unit 102 supplies registration video data described below to the target determination unit 107 and the feature motion determination unit 108a, and acquires skeleton information about a person extracted from the registration video data as registration skeleton information from the feature motion determination unit 108a. Then, the registration unit 102 registers the acquired registration skeleton information in association with a target ID and a registration motion ID in the motion DB 103. The target ID may be, for example, a number that uniquely identifies a player in association with a uniform number of a player on A team (own team) or B team (opponent team). As described below by using FIG. 7, the registration motion ID may be a number that uniquely identifies a feature motion (for example, a dribble, a shot, and the like).

Next, the registration unit 102 can also perform sequence registration processing in response to a sequence registration request from an operator. Specifically, the registration unit 102 arranges registration motion IDs in a chronological order, based on information about the chronological order, and generates a registration motion sequence. At this time, in a case where a sequence registration request is related to a normal motion (for example, a dribble success), the registration unit 102 registers the generated registration motion sequence as a normal feature motion sequence FAS in the motion sequence table 104. On the other hand, in a case where a sequence registration request is related to an abnormal motion (for example, a dribble failure), the registration unit 102 registers the generated registration motion sequence as an abnormal motion sequence AAS in the motion sequence table 104.

The motion DB 103 is a storage device that stores, in association with a target ID and a registration motion ID, a pose included in a normal motion of a target or registration skeleton information associated with each motion. Further, the motion DB 103 may store, in association with a registration motion ID, positional information in a field and a pose included in an abnormal motion or registration skeleton information associated with each motion.

The motion sequence table 104 stores the normal feature motion sequence FAS and the abnormal motion sequence AAS. In the present second example embodiment, the motion sequence table 104 stores a plurality of the normal feature motion sequences FAS and a plurality of the abnormal motion sequences AAS.

The first video generation unit 105 is also referred to as a first video generation means. The first video generation unit 105 generates first video data (also referred to as distribution data or distribution video data) for distribution to a viewer, based on video data captured by the camera 300. In some of the example embodiments, a video generated by the first video generation unit 105 may be a live distribution video. The first video generation unit 105 may include switcher equipment for switching a video in real time. A switching operation may be performed on the switcher equipment by a staff in charge of video production. The first video generation unit 105 can distribute a generated video to one or more of the user terminals 200 via the network N and the distribution unit 111.

In some of the example embodiments, the first video generation unit 105 can perform various types of processing on a captured video, based on an instruction (for example, a user input) from the user terminal 200. The first video generation unit 105 can process a live video in such a way as to indicate, for example, a comment and the number of favorites (for example, the number of “likes”) for the live video. In the other example embodiment, for example, the first video generation unit 105 can process a live video in such a way as to indicate a score during a game.

In some of the example embodiments, the first video generation unit 105 can also generate a first video including sound data that collect a shout from an audience seat by a microphone. In the other example embodiment, the first video generation unit 105 can also generate a first video including sound data that collect a sound (for example, a sound of a ball hitting a goal net) from a specific instrument (for example, a goal net and a bench) by a microphone. Further, a microphone may be installed at various places. For example, in another example, a microphone that collects a sound of a coach and a player may be attached to a bench of each team.

The target determination unit 107 is also referred to as a target determination means. The target determination unit 107 determines a target (for example, a specific player) from capturing video data or distribution video data. The target determination unit 107 can also determine a desired target (for example, a specific player) by receiving an instruction from an operator or a viewer (user terminal 200). In some of the example embodiments, a viewer can also designate a desired team (for example, A team) or a desired target (for example, a specific player) via the user terminal 200. The target determination unit 107 can detect an image region (body region) of a body of a person from a frame image included in video data, and determine the person as a body image. The target determination unit 107 can determine a target by identifying an identification number (for example, a uniform number of a player) of the target by using a known image recognition technique. Further, the target determination unit 107 may determine a target by recognizing a face of the target by using a known face recognition technique.

The feature motion determination unit 108a is also referred to as a feature motion determination means. The feature motion determination unit 108a extracts skeleton information about at least a part of a body of a person, based on a feature of a joint and the like of the person being recognized in a body image, by using a skeleton estimation technique of a person using machine learning. The feature motion determination unit 108a can determine a motion of a body along a time series of a target, based on a plurality of continuous frames of capturing data or distribution data. Skeleton information is information formed of a “keypoint” (also referred to as a feature point) being a characteristic point such as a joint and a “bone (bone link)” (also referred to as a pseudo skeleton) indicating a link between keypoints. The feature motion determination unit 108a may use a skeleton estimation technique such as OpenPose, for example. The feature motion determination unit 108a converts skeleton information extracted from video data acquired during operation into a motion ID by using the motion DB 103. In this way, the feature motion determination unit 108a determines a motion of a target (for example, a player). Specifically, first, the feature motion determination unit 108a determines registration skeleton information whose degree of similarity to extracted skeleton information is equal to or more than a predetermined threshold value from among pieces of registration skeleton information being registered in the motion DB 103. Then, the feature motion determination unit 108a determines, as a motion ID associated with a person included in an acquired frame image, a registration motion ID associated with the determined registration skeleton information.

The trigger detection unit 109a is also referred to as a trigger detection means. The trigger detection unit 109a detects a trigger for generating a second video from acquired video data. The second video is a distribution video different from the first video. The second video may be a video of past highlights or may be a real-time video. Examples of the trigger include a change in score data, a change in volume of sound emitted from an audience, a predetermined trigger motion of a referee of a game, a predetermined trigger motion of a target, and a comment of a viewer or the number of favorites in distribution data, which are not limited thereto.

Specifically, for example, the trigger detection unit 109a can detect a change in a score of a specific team (for example, an increase in a score of A team) from live distribution video data. Further, the trigger detection unit 109a can detect that volume of a shout from an audience seat is equal to or more than a threshold value (that is, it is getting lively or a big chance is coming) from live distribution video data or capturing data. Further, the trigger detection unit 109a can detect a predetermined trigger motion of a referee of a game (for example, a motion of a chief referee blowing a whistle and a motion of an assistant referee raising a flag) from live distribution video data or capturing data. The trigger detection unit 109a can detect that a ball goes into a goal from live distribution video data or capturing data. The trigger detection unit 109a can detect, as a trigger, a predetermined motion (for example, performance after a goal) of a target from live distribution video data or capturing data. The trigger detection unit 109a can detect, as a trigger, a predetermined motion (for example, a player who keeps a ball enters a penalty area) of a target from live distribution video data or capturing data. In the other example embodiment, the trigger detection unit 109a can detect that a comment of a viewer or the number of favorites in live distribution video data exceeds a threshold value (that is, it is getting lively or a big chance is coming).

The second video generation unit 110a is also referred to as a second video generation means. The second video generation unit 110a generates a second video for distribution to a viewer, based on a determined target, a determined feature motion of the target, and a detected trigger. The second video may be, for example, a video of a highlighted scene before a time at which a predetermined trigger is detected. Further, in a different example, the second video may be a video (for example, a goal scene) that should not be missed by a viewer after a time at which a predetermined trigger is detected.

Specifically, for example, in a case where the trigger detection unit 109a detects a change in a score of a specific team (for example, an increase in a score of A team) from live distribution video data, a goal scene may be included in distribution data or capturing video data before the time. Therefore, the second video generation unit 110a can generate, for a viewer, a second video (for example, a goal scene) including a determined feature motion (for example, a shot scene) of a desired target (for example, a player with a uniform number 10).

Further, in a different example, for example, in a case where the trigger detection unit 109a detects that volume of a shout from an audience seat is equal to or more than a threshold value from live distribution video data or capturing data, a video (for example, a goal scene, a scene where a victory or a defeat is decided, or a decisive chance) that should not be missed by a viewer may be included in distribution data or capturing video data after the time. Therefore, the second video generation unit 110a can generate, for a viewer, a second video (for example, a goal scene, a scene where a victory or a defeat is decided, or a decisive chance) including a determined feature motion (for example, a shot, a dribble, a pass, and the like in a penalty area) of a desired target.

The distribution unit 111 is also referred to as a distribution means. The distribution unit 111 distributes a generated first image or second image to one or more user terminals via the network N. Further, the distribution unit 111 includes a communication unit that bidirectionally communicates with the user terminal 200. The communication unit is a communication interface with the network N.

FIG. 4 also illustrates a configuration of the user terminal 200 according to the second example embodiment.

The user terminal 200 includes a communication unit 201, a control unit 202, a display unit 203, and a sound output unit 204. The user terminal 200 is achieved by a computer.

The communication unit 201 is also referred to as a communication means. The communication unit 201 is a communication interface with the network N. The control unit 202 is also referred to as a control means. The control unit 202 performs control of hardware included in the user terminal 200.

The display unit 203 is a display apparatus. The sound output unit 204 is a sound output apparatus including a speaker. in this way, a user can view various videos (distribution video data) such as sports and plays while the user is at a stadium, a theater, a home, or the like.

An input unit 205 receives an instruction from a user. For example, the input unit 205 may be a touch panel formed in combination with the display unit 203. A user can make a comment on a live distribution video and the like and register the live distribution video and the like as a favorite via the input unit 205. Further, a user can register a favorite team and a favorite player via the input unit 205.

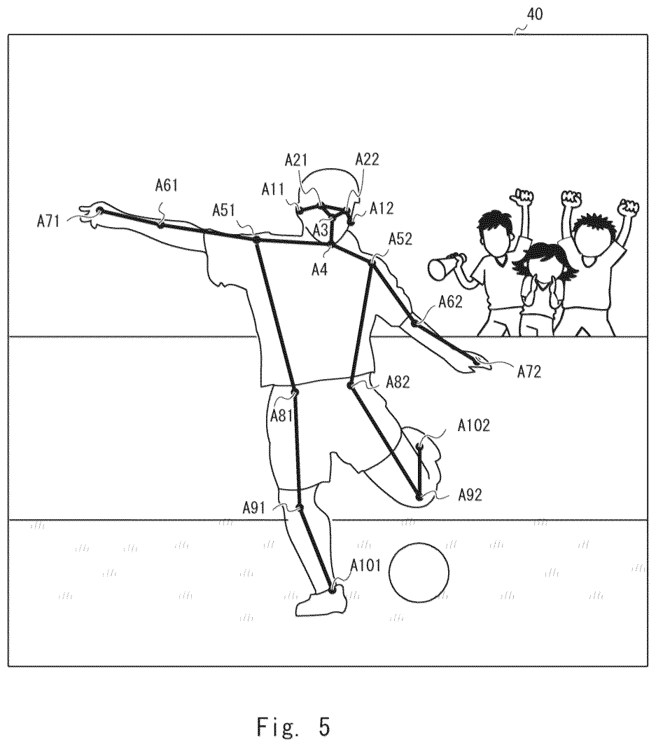

FIG. 5 illustrates skeleton information about a player who takes a shot being extracted from a frame image 40 included in video data according to the second example embodiment. The frame image 40 is an image in which a player on a field is captured from the front. In the frame image 40, a target is determined by the target determination unit 107 and the feature motion determination unit 108a described above, and a feature motion is determined from a plurality of continuous frames. A plurality of keypoints and a plurality of bones being detected from a whole body are included in skeleton information about the player (for example, a player with a uniform number 10) illustrated in FIG. 5. As an example, FIG. 5 illustrates, as keypoints, a right ear A11, a left ear A12, a right eye A21, a left eye A22, a nose A3, a neck A4, a right shoulder A51, a left shoulder A52, a right elbow A61, a left elbow A62, a right hand A71, a left hand A72, a right waist A81, a left waist A82, a right knee A91, a left knee A92, a right ankle A101, and a left ankle A102.

The feature motion determination unit 108a of the video distribution apparatus 10 compares such skeleton information with associated registration skeleton information (for example, registration skeleton information about a player who succeeds in shooting), determines whether the pieces of information are similar, and thus determines a feature motion. In the frame image 40, audiences in audience seats are also captured, but the target determination unit 107 can determine only the player and determine only a feature motion of the player by distinguishing between the player on the field and the audiences in the audience seats.

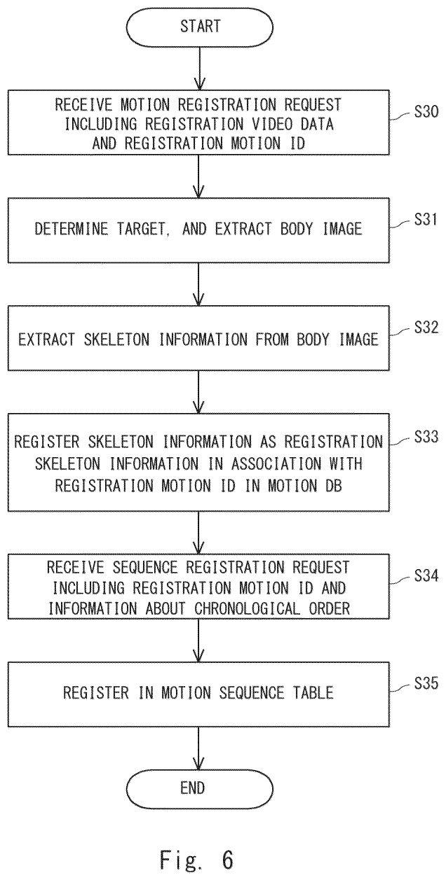

FIG. 6 is a flowchart illustrating a registration method of a registration motion ID and a registration motion sequence by an operator according to the second example embodiment. The registration motion is also referred to as a reference motion, and a feature motion of a player and the like can be detected from a video acquired during operation by recording the registration motion in advance.

First, the registration unit 102 of the video distribution apparatus 10 receives, from a user interface of the video distribution apparatus 10, a motion registration request from an operator including registration video data and a registration motion ID (S30). Next, the registration unit 102 supplies the registration video data from the video acquisition unit 101 to the target determination unit 107 and the feature motion determination unit 108a. The target determination unit 107 that has acquired the registration video data determines a person (for example, a name, a uniform number, and the like of a player) from a frame image included in the registration video data, and the feature motion determination unit 108a further extracts a body image from the frame image included in the registration video data (S31). Next, as illustrated in FIG. 5, the feature motion determination unit 108a extracts skeleton information from the body image (S32). Next, the registration unit 102 acquires the skeleton information from the feature motion determination unit 108a, and registers the acquired skeleton information as registration skeleton information in association with the registration motion ID in the motion DB 103 (S33). Note that the registration unit 102 may set all pieces of skeleton information extracted from a body image as registration skeleton information, or may set only some pieces of skeleton information (for example, skeleton information about a foot, a waist, and a trunk) as registration skeleton information. The registration unit 102 receives, from the user interface of the video distribution apparatus 10, a sequence registration request from an operator including a plurality of registration motion IDs and information about a chronological order of each motion (S34). Next, the registration unit 102 registers, in the motion sequence table 104, a registration motion sequence (the normal motion sequence FAS or the abnormal motion sequence AAS) in which the registration motion IDs are arranged based on the information about the chronological order (S35).

FIG. 7 is a table illustrating a representative feature motion according to the second example embodiment. A content of a representative motion in soccer includes a shot, a pass, a dribble (including a feint), a header, and a trap, which are not limited thereto. Further, in the other example embodiment, a different feature motion can be defined in association with a different sport, a play, or the like. Each motion may be provided with an associated motion ID (for example, A to E). The registration method described above by using FIG. 6 may be performed on each motion. In some of the example embodiments, a reference motion may be registered in association with a target ID for each target (for example, a player). The reference motion is stored in the motion DB 103.

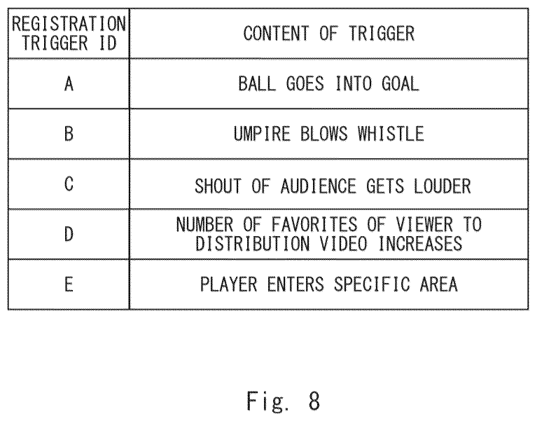

FIG. 8 is a table illustrating a representative trigger according to the second example embodiment. A content of a representative trigger in soccer includes that a ball goes into a goal, a referee blows a whistle, a shout of an audience gets louder, the number of favorites (for example, the number of likes) of a viewer to a distribution video increases, a player enters a specific area (for example, a penalty area), and the like, which are not limited thereto. Each trigger may be provided with an associated trigger ID (for example, A to E). Some of trigger motions may be registered by the registration method described above by using FIG. 6. For example, for a motion of a referee blowing a whistle, a similar past motion may be registered as registration skeleton information. Further, some of the trigger motions may be associated with positional information in a field. For example, a trigger motion of a player entering a specific area (for example, a penalty area) may be determined by determining a position of a player in a video and determined based on whether the position is located in the specific area or outside the area.

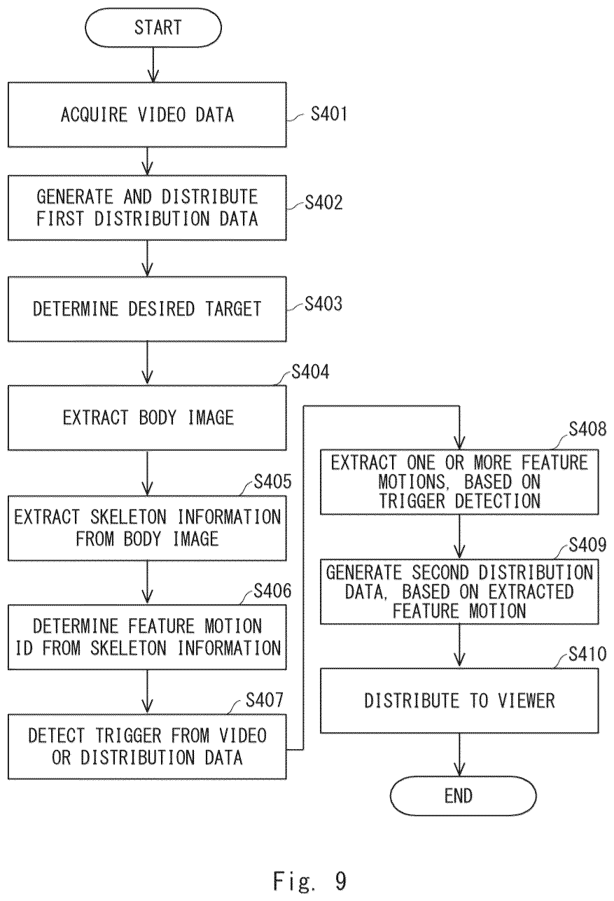

FIG. 9 is a flowchart illustrating a video distribution method by the video distribution apparatus 10 according to the second example embodiment. Herein, an example of extracting a feature motion of a specific target after a trigger being a goal is detected and generating a distribution video will be described.

First, the video acquisition unit 101 of the video distribution apparatus 10 acquires video data directly from the camera 300, or from the video database 500 (S401). Next, the first video generation unit 105 generates first distribution video data, and distributes the first distribution video data to the user terminal 200 of a viewer via the network N (step S402). For example, the first distribution video data may be a live video and be distributed to the user terminal 200 in real time. Next, the target determination unit 107 determines a desired target (step S403). For example, the target determination unit 107 can determine a player with a uniform number 10 on A team by using a known image recognition technique by an instruction from an operator or a viewer (user terminal 200). In the other example embodiment, a plurality of players (for example, all players on A team) can also be determined. Furthermore, in the other example embodiment, all players on a field (all players on A team and B team) can also be determined. The target determination unit 107 extracts a body image of the player from a frame of the first distribution video or capturing video data in the capturing video database 500 (step S404). Next, the feature motion determination unit 108a extracts skeleton information from the body image (S405). The feature motion determination unit 108a calculates a degree of similarity between at least a part of the extracted skeleton information and each piece of registration skeleton information being registered in the motion DB 103, and determines, as a motion ID, a registration motion ID associated with the registration skeleton information whose degree of similarity is equal to or more than a predetermined threshold value (S406). For example, in the present example, a plurality of motion IDs of a trap, a dribble, and a shot of the player, that is, E, C, and A (FIG. 7) are determined.

Next, the trigger detection unit 109a detects a trigger for generating a second distribution video from the first distribution video data or the capturing data (step S407). For example, in the present example, the trigger detection unit 109a detects, as a trigger, a ball going into a goal (as illustrated in FIG. 8, a trigger ID is A) from the distribution video data.

The second video generation unit 110a extracts the determined feature motion of the target from the capturing data in response to detection of the trigger (step S408), and generates additional distribution data (also referred to as second distribution video data) for distribution to a viewer (step S409). The second video generation unit 110a may extract a feature motion determined for a desired target from a video at a time before a current time according to a kind of a trigger, and generate a second video, or may determine and extract a feature motion from a real-time video, and generate a second video. In some of the example embodiments, the second video generation unit 110a may decide various capturing periods of time (for example, 30 seconds, 1 minute, 2 minutes, and the like) according to a kind of a trigger. In the present example, since a ball going into a goal (as illustrated in FIG. 8, a trigger ID is A) is set as a trigger, a feature motion of the player with the uniform number 10 is extracted from a video (for example, a video since a trigger detection time until before a predetermined period of time (for example, before 1 minute)) retroactive from a time at which the trigger is detected. Therefore, in the present example, a video for a predetermined period of time (for example, 30 seconds) during which a plurality of feature motions of a trap, a dribble, and a shot of the player are extracted is generated. Further, in some of the example embodiments, a second video may be generated in such a way as to include a predetermined period of time (for example, 10 seconds) before a first feature motion in terms of time and a predetermined period of time (for example, 10 seconds) after a last feature motion in terms of time. Further, in the other example embodiment, a second video may be generated in such a way as to include a predetermined time interval (for example, a few frames) before and after a middle frame with reference to the middle frame among a plurality of frames representing an extracted feature motion. Furthermore, in the other example embodiment, a second video may be generated in such a way as to include a predetermined period of time (for example, a few frames) before a first frame in terms of time and a predetermined period of time (for example, a few frames) after a last frame in terms of time among a plurality of frames representing an extracted feature motion.

The distribution unit 111 distributes the second video data to the user terminal 200 via the network N (step S410). In this way, for example, an audience who is watching a game at a stadium can view a highlighted video generated in such a manner via the user terminal 200.

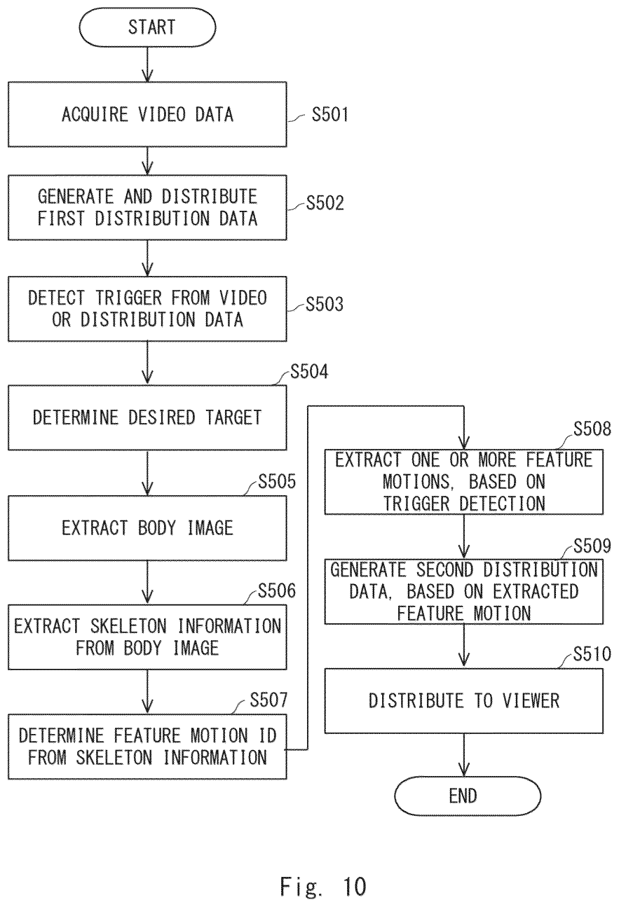

FIG. 10 is a flowchart illustrating a video distribution method by the video distribution apparatus 10 according to the other example embodiment. Herein, an example of extracting a feature motion of a specific target from a captured real-time video after a trigger being the specific target entering a predetermined area (for example, a penalty area) is detected and generating a distribution video will be described.

First, the video acquisition unit 101 of the video distribution apparatus 10 acquires video data directly from the camera 300, or from the video database 500 (S501). Next, the first video generation unit 105 generates first distribution video data, and distributes the first distribution video data to the user terminal 200 of a viewer via the network N (step S502). For example, the first distribution video data may be a live video and be distributed to the user terminal 200 in real time.

Next, the trigger detection unit 109a detects a trigger for generating a second distribution video from the first distribution video data or capturing data (step S503). For example, in the present example, the trigger detection unit 109a detects, as a trigger, a specific target entering a predetermined area (for example, a penalty area) (as illustrated in FIG. 8, a trigger ID is E) from the distribution video data.

Next, the target determination unit 107 determines a desired target (step S504). For example, the target determination unit 107 can determine a player with a uniform number 10 on A team by using a known image recognition technique by an instruction from an operator or a viewer (user terminal 200). In the other example embodiment, a plurality of players (for example, all players on A team) can also be determined. Furthermore, in the other example embodiment, all players on a field (all players on A team and B team) can also be determined. The target determination unit 107 extracts a body image of the player from a frame of the first distribution video or the capturing video data in the capturing video database 500 (step S505). Next, the feature motion determination unit 108a extracts skeleton information from the body image (step S506). The feature motion determination unit 108a calculates a degree of similarity between at least a part of the extracted skeleton information and each piece of registration skeleton information being registered in the motion DB 103, and determines, as a motion ID, a registration motion ID associated with the registration skeleton information whose degree of similarity is equal to or more than a predetermined threshold value (step S507). For example, in the present example, a plurality of motion IDs of a dribble and a shot of the player, that is, C and A (FIG. 7) are determined.

The second video generation unit 110a extracts the determined feature motion of the target from the capturing data in response to detection of the trigger (step S508), and generates additional distribution data (also referred to as second distribution video data) for distribution to a viewer (step S509). In the present example, since a specific target entering a predetermined area (as illustrated in FIG. 8, a trigger ID is E) is set as a trigger, a feature motion of the player with the uniform number 10 is extracted from a real-time video (for example, a video after a trigger detection time). Therefore, in the present example, for example, a video in which a plurality of feature motions of a dribble and a shot of the player in a penalty area are extracted is generated.

The distribution unit 111 distributes the second video data to the user terminal 200 via the network N (step S510). In this way, for example, a viewer who is viewing at home can view a video that is generated in such a manner and should not be missed via the user terminal 200. Further, even when a viewer is doing a thing other than viewing, the viewer can view a video that should not be missed by receiving notification that the second video data are distributed to the user terminal.

As described above, the second video generation unit 110a may extract a feature motion determined for a desired target from a video at a time before a current time according to a kind of a trigger, and generate a second video, or may determine and extract a feature motion from a real-time video, and generate a second video.

The flowcharts in FIGS. 9 and 10 illustrate a specific order of execution, but an order of execution may be different from the illustrated manner. For example, an order of execution of two or more steps may be switched from the illustrated order. Further, two or more steps continuously illustrated in FIGS. 9 and 10 may be simultaneously or partially simultaneously executed. Furthermore, in some of the example embodiments, one or the plurality of steps illustrated in FIGS. 9 and 10 may be skipped or omitted.

### Third Example Embodiment

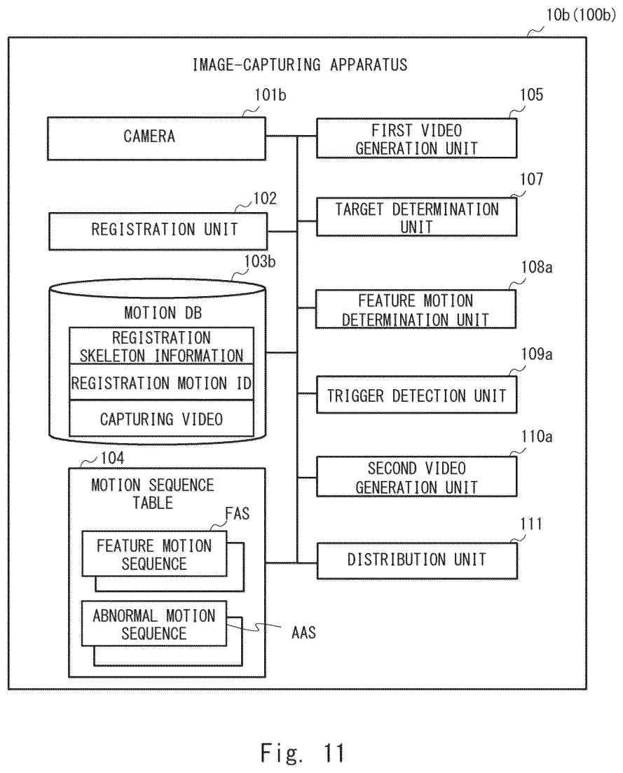

FIG. 11 is a block diagram of an exemplification illustrating a configuration of an image-capturing apparatus. An image-capturing apparatus 10b may include a camera 101b, a registration unit 102, a motion database 103b, a motion sequence table 104, a first video generation unit 105, a target determination unit 107, a feature motion determination unit 108a, a trigger detection unit 109a, a second video generation unit 110a, and a distribution unit 111. Note that the configuration of the image-capturing apparatus 10b is basically similar to the video distribution apparatus 10 described above, and thus description will be omitted, but the image-capturing apparatus 10b is different in a point that the image-capturing apparatus 10b includes the camera 101b built-in. The camera 101b includes an image sensor such as, for example, a complementary metal oxide semiconductor (CMOS) sensor and a charge coupled device (CCD) sensor. Further, capturing video data created by the camera 101b are stored in the motion database 103b. The configuration of the image-capturing apparatus 10b is not limited to this, and various modifications may be performed.

The image-capturing apparatus 10b may be mounted as an intelligent camera on various modules. For example, the image-capturing apparatus 10b may be mounted on various moving bodies such as a drone and a vehicle. The image-capturing apparatus 10b also has a function of an image processing apparatus. In other words, as described in the second example embodiment, the image-capturing apparatus 10b can also generate a first video, determine a target, determine a feature motion, detect a trigger, and generate a second video from a capturing video.

Further, in some of the example embodiments, the image-capturing apparatus (intelligent camera) according to the third example embodiment and the video distribution apparatus according to the second example embodiment may have a part of the functions separated and achieve the object of the present disclosure.

Note that the present disclosure is not limited to the example embodiments described above, and may be appropriately modified without departing from the scope of the present disclosure.

The example embodiments described above have been described above as a configuration of hardware, which is not limited thereto. The present disclosure can also achieve any processing by causing a processor to execute a computer program.

In the example described above, in a case where the program is read by a computer, the program includes a command group (or software codes) for causing the computer to perform one or more of the functions described in the example embodiments. The program may be stored in a non-transitory computer-readable medium or a tangible storage medium. Examples of the computer-readable medium or the tangible storage medium include a random-access memory (RAM), a read-only memory (ROM), a flash memory, a solid-state drive (SSD), or other memory technique, a CD-ROM, a digital versatile disc (DVD), a Blu-ray (registered trademark) disc, or other optical disc storage, a magnetic cassette, a magnetic tape, a magnetic disc storage, or other magnetic storage device, which are not limited thereto. The program may be transmitted on a transitory computer-readable medium or a communication medium. Examples of the transitory computer-readable medium or the communication medium include electrical, optical, acoustic, or other form of propagation signals, which are not limited thereto.

A part or the whole of the above-described example embodiments may also be described as in supplementary notes below, which is not limited thereto.

### (Supplementary Note 1)

An image processing apparatus including:
a feature motion determination unit that analyzes a motion of a target, based on capturing data, and determines one or more feature motions;
a trigger detection unit that detects a trigger from the capturing data or distribution data for distribution to one or more viewers being generated from the capturing data; and
a generation unit that extracts one or more of the determined feature motions of the target from the capturing data in response to detection of the trigger, and generates different distribution data for distribution to one or more viewers, based on the feature motion.

### (Supplementary Note 2)

The image processing apparatus according to Supplementary Note 1, wherein
the feature motion determination unit determines a feature point and a pseudo skeleton of a body of the target, based on the capturing data.

### (Supplementary Note 3)

The image processing apparatus according to Supplementary Note 1 or 2, wherein
the feature motion determination unit determines a motion of a body along a time series of the target, based on a plurality of continuous frames of the capturing data or distribution data.

### (Supplementary Note 4)

The image processing apparatus according to any one of Supplementary Notes 1 to 3, wherein
the feature motion determination unit stores a reference motion associated for each target, and detects a feature motion by using a reference motion of each target.

### (Supplementary Note 5)

The image processing apparatus according to any one of Supplementary Notes 1 to 4, wherein
the trigger detection unit detects, as a trigger, a change in score data about a game in the distribution data.

### (Supplementary Note 6)

The image processing apparatus according to any one of Supplementary Notes 1 to 5, wherein
the trigger detection unit detects that volume emitted from an audience in the distribution data or capturing data exceeds a threshold value.

### (Supplementary Note 7)

The image processing apparatus according to any one of Supplementary Notes 1 to 6, wherein
the trigger detection unit detects a predetermined motion of a referee of a game in the distribution data or capturing data.

### (Supplementary Note 8)

The image processing apparatus according to any one of Supplementary Notes 1 to 7, wherein
the trigger detection unit detects, as a trigger, a predetermined trigger motion of a target in the distribution data.

### (Supplementary Note 9)

The image processing apparatus according to any one of Supplementary Notes 1 to 8, wherein
the trigger detection unit detects that a comment of a viewer or the number of favorites in the distribution data exceeds a threshold value.

### (Supplementary Note 10)

The image processing apparatus according to any one of Supplementary Notes 1 to 9, wherein
the generation unit generates a different distribution video for a different predetermined period of time according to a kind of the trigger.

### (Supplementary Note 11)

The image processing apparatus according to any one of Supplementary Notes 1 to 9, further including
a target determination unit that determines a desired target among one or more targets included in the capturing data.

### (Supplementary Note 12)

An image processing method including:
analyzing a motion of a target, based on capturing data, and determining one or more feature motions;
detecting a trigger from the capturing data or distribution data for distribution to one or more viewers being generated from the capturing data; and
extracting one or more of the determined feature motions of the target from the capturing data in response to detection of the trigger, and generating different distribution data for distribution to one or more viewers, based on the feature motion.

### (Supplementary Note 13)

The image processing method according to Supplementary Note 12, further including,
in determination of the feature motion, determining a feature point and a pseudo skeleton of a body of the target, based on the capturing data.

### (Supplementary Note 14)

The image processing method according to Supplementary Note 12 or 13, further including,
in determination of the feature motion, determining a motion of a body along a time series of the target, based on a plurality of continuous frames of the capturing data or distribution data.

### (Supplementary Note 15)

The image processing method according to any one of Supplementary Notes 12 to 14, further including,
in determination of the feature motion, storing a reference motion associated for each target, and detecting a feature motion by using a reference motion of each target.

### (Supplementary Note 16)

The image processing method according to any one of Supplementary Notes 12 to 15, further including,
in detection of the trigger, detecting, as a trigger, a change in score data about a game in the distribution data.

### (Supplementary Note 17)

The image processing method according to any one of Supplementary Notes 12 to 16, further including,
in detection of the trigger, detecting that volume emitted from an audience in the distribution data or capturing data exceeds a threshold value.

### (Supplementary Note 18)

The image processing method according to any one of Supplementary Notes 12 to 17, further including,
in detection of the trigger, detecting a predetermined motion of a referee of a game in the distribution data or capturing data.

### (Supplementary Note 19)

The image processing method according to any one of Supplementary Notes 12 to 18, further including,
in detection of the trigger, detecting, as a trigger, a predetermined trigger motion of a target in the distribution data.

### (Supplementary Note 20)

The image processing method according to any one of Supplementary Notes 12 to 19, further including,
in detection of the trigger, detecting that a comment of a viewer or the number of favorites in the distribution data exceeds a threshold value.

### (Supplementary Note 21)

The image processing method according to any one of Supplementary Notes 12 to 20, further including
generating a different distribution video for a different predetermined period of time according to a kind of the trigger.

### (Supplementary Note 22)

A non-transitory computer-readable medium that stores a program for causing a computer to execute a command including:
analyzing a motion of a target, based on capturing data, and determining one or more feature motions;
detecting a trigger from the capturing data or distribution data for distribution to one or more viewers being generated from the capturing data; and
extracting one or more of the determined feature motions of the target from the capturing data in response to detection of the trigger, and generating different distribution data for distribution to one or more viewers, based on the feature motion.

### REFERENCE SIGNS LIST

1 VIDEO DISTRIBUTION SYSTEM
7 FIELD
10 VIDEO DISTRIBUTION APPARATUS
10b IMAGE-CAPTURING APPARATUS
40 FRAME IMAGE
100 IMAGE PROCESSING APPARATUS
101 VIDEO ACQUISITION UNIT
101b CAMERA
102 REGISTRATION UNIT
103 MOTION DB
103b MOTION DB
104 MOTION SEQUENCE TABLE
105 FIRST VIDEO GENERATION UNIT
107 TARGET DETERMINATION UNIT
108 FEATURE MOTION DETERMINATION UNIT
108a FEATURE MOTION DETERMINATION UNIT
109 TRIGGER DETECTION UNIT
109a TRIGGER DETECTION UNIT
110 GENERATION UNIT
110a SECOND VIDEO GENERATION UNIT
111 DISTRIBUTION UNIT
200 USER TERMINAL
201 COMMUNICATION UNIT
202 CONTROL UNIT
203 DISPLAY UNIT
204 SOUND OUTPUT UNIT
205 INPUT UNIT
300 CAMERA
500 CAPTURING VIDEO DATABASE
N NETWORK

What is claimed is:

1. An image processing apparatus comprising:
at least one memory storing instructions, and
at least one processor configured to execute the instructions to;
analyze a motion of a target, based on capturing data, and determines one or more feature motions;
detect a trigger from the capturing data or distribution data for distribution to one or more viewers being generated from the capturing data; and
extract one or more of the determined feature motions of the target from the capturing data in response to detection of the trigger, and generates different distribution data for distribution to one or more viewers, based on the feature motion.

2. The image processing apparatus according to claim 1, wherein
the at least one processor is configured to execute the instructions to determine a feature point and a pseudo skeleton of a body of the target, based on the capturing data.

3. The image processing apparatus according to claim 1, wherein
the at least one processor is configured to execute the instructions to determine a motion of a body along a time series of the target, based on a plurality of continuous frames of the capturing data or the distribution data.

4. The image processing apparatus according to claim 1, wherein
the at least one processor is configured to execute the instructions to store a reference motion associated for each target, and detects a feature motion by using a reference motion of each target.

5. The image processing apparatus according to claim 1 wherein
the at least one processor is configured to execute the instructions to detect, as a trigger, a change in score data about a game in the distribution data.

6. The image processing apparatus according to claim 1, wherein
the at least one processor is configured to execute the instructions to detect that volume emitted from an audience in the distribution data or the capturing data exceeds a threshold value.

7. The image processing apparatus according to claim 1, wherein
the at least one processor is configured to execute the instructions to detect a predetermined motion of a referee of a game in the distribution data or the capturing data.

8. The image processing apparatus according to claim 1, wherein
the at least one processor is configured to execute the instructions to detect, as a trigger, a predetermined trigger motion of a target in the distribution data.

9. The image processing apparatus according to claim 1, wherein
the at least one processor is configured to execute the instructions to detect that a comment of a viewer or the number of favorites in the distribution data exceeds a threshold value.

10. The image processing apparatus according to claim 1, wherein
the at least one processor is configured to execute the instructions to generate a different distribution video for a different predetermined period of time according to a kind of the trigger.

11. The image processing apparatus according to claim 1,
wherein the at least one processor is configured to execute the instructions to determine a desired target among one or more targets included in the capturing data.

12. An image processing method comprising:
analyzing a motion of a target, based on capturing data, and determining one or more feature motions;
detecting a trigger from the capturing data or distribution data for distribution to one or more viewers being generated from the capturing data; and
extracting one or more of the determined feature motions of the target from the capturing data in response to detection of the trigger, and generating different distribution data for distribution to one or more viewers, based on the feature motion.

13. The image processing method according to claim 12, further comprising,
in determination of the feature motion, determining a feature point and a pseudo skeleton of a body of the target, based on the capturing data.

14. The image processing method according to claim 12, further comprising,
in determination of the feature motion, determining a motion of a body along a time series of the target, based on a plurality of continuous frames of the capturing data or the distribution data.

15. The image processing method according to claim 12, further comprising,
in determination of the feature motion, storing a reference motion associated for each target, and detecting a feature motion by using a reference motion of each target.

16. The image processing method according to claim 12, further comprising,
in detection of the trigger, detecting, as a trigger, a change in score data about a game in the distribution data.

17. The image processing method according to claim 12, further comprising,
in detection of the trigger, detecting that volume emitted from an audience in the distribution data or the capturing data exceeds a threshold value.

18. The image processing method according to claim 12, further comprising,
in detection of the trigger, detecting a predetermined motion of a referee of a game in the distribution data or the capturing data.

19. The image processing method according to claim 12, further comprising,
in detection of the trigger, detecting, as a trigger, a predetermined trigger motion of a target in the distribution data.

20.-21. (canceled)

22. A non-transitory computer-readable medium that stores a program for causing a computer to execute a command including:
analyzing a motion of a target, based on capturing data, and determining one or more feature motions;
detecting a trigger from the capturing data or distribution data for distribution to one or more viewers being generated from the capturing data; and
extracting one or more of the determined feature motions of the target from the capturing data in response to detection of the trigger, and generating different distribution data for distribution to one or more viewers, based on the feature motion.
